(19) United States
(12) Patent Application Publication
(10) Pub. No.: US 2023/0129337 A1
(43) Pub. Date: Apr. 27, 2023

(54) SILVER-TITANIUM OXIDE COMPLEX PARTICLE AND METHOD OF PREPARING THE SAME

(71) Applicant: CHEOMDANLAB INC., Gwangju (KR)

(72) Inventors: Byeong Hoon LEE, Gwangju (KR); Byeong-Yun OH, Gwangju (KR); Kyung-Im SHIN, Gwangju (KR); In Ha SEO, Gwangju (KR); Kyoung Sun JUNG, Cheonan-si (KR); Jae Won JANG, Gwangju (KR); Jun Sub AN, Gwangju (KR); Tae Jun KIM, Gwangju (KR); Yong Hyun CHO, Gwangju (KR); Ha Jun JANG, Gwangju (KR)

(21) Appl. No.: 17/539,021

(22) Filed: Nov. 30, 2021

(30) Foreign Application Priority Data
Oct. 22, 2021 (KR) 10-2021-0142134

(51) Int. Cl. B01J 23/66; B01J 21/06; B01J 35/00; B01J 35/02; B01J 37/04; B01J 37/08; B01J 37/00

(52) U.S. Cl. CPC B01J 23/66; B01J 21/063; B01J 35/004; B01J 35/023; B01J 37/04; B01J 37/08; B01J 37/009

(57) ABSTRACT

This application relates to silver-titanium oxide complex particles. In one aspect, the silver-titanium oxide complex particles include a plurality of titanium oxide nanoparticles aggregated with each other. The silver-titanium oxide complex particles may also include a silver component bonded on the surface of the titanium oxide nanoparticles, and have an energy band gap of 3.1 eV or less. According to various embodiments, the silver-titanium oxide complex particles show excellent optical characteristics.

### CROSS-REFERENCE TO RELATED APPLICATION

This application is based on and claims priority under 35 USC § 119 to Korean Patent Application No. 10-2021-0142134, filed on Oct. 22, 2021, in the Korean Intellectual Property Office, the disclosure of which is incorporated by reference herein in its entirety.

### BACKGROUND

### Technical Field

The present disclosure relates to a silver-titanium oxide complex particle and a method of preparing the same. Specifically, the present disclosure relates to a silver-titanium oxide complex particle in which a silver component is bonded on titanium oxide particles and a method of manufacturing the same.

### Description of Related Technology

Nanoparticles are particles having a size of nanometer (nm: 10⁻⁹ m) scale, and due to the quantum confinement effect in which the energy required for electron transition changes depending on the size of the material and a large specific surface area, they show optical, electrical, and magnetic properties that are completely different from those of bulky materials. Due to these properties, the use of nanoparticles in the fields of catalysts, electromagnetics, optics, medicine, etc. is getting more attention.

### SUMMARY

The present disclosure provides a silver-titanium oxide complex particle having excellent optical properties.

The present disclosure provides a method of preparing silver-titanium oxide complex particles having excellent optical properties.

Additional aspects will be set forth in part in the description which follows and, in part, will be apparent from the description, or may be learned by practice of the presented embodiments of the disclosure.

Silver-titanium oxide complex particles according to embodiments include a plurality of titanium oxide nanoparticles aggregated with each other, and a silver component bonded on the surface of the titanium oxide nanoparticles, and the silver-titanium oxide complex particles may have an energy band gap of 3.1 eV or less.

In some embodiments, the average particle diameter of the titanium oxide nanoparticles may be from about 5 nm to about 40 nm.

In some embodiments, the silver-titanium complex particles may have an average particle diameter of about 100 nm to about 500 nm.

In some embodiments, the silver component may include silver nanoparticles having an average particle diameter of about 20 nm to about 100 nm.

In some embodiments, the titanium oxide nanoparticles may be aggregated with each other to form a titanium oxide aggregate, and at least a portion of the silver component may be supported inside the titanium oxide aggregate.

In some embodiments, the silver-titanium oxide complex particle may have a maximum absorption wavelength greater than 320 nm.

In some embodiments, the silver-titanium oxide complex particle may have a silver component having an average particle diameter of about 30 nm to about 80 nm distributed on the surface and inside of the titanium oxide aggregate having an average particle diameter of about 200 nm to about 400 nm.

In some embodiments, the silver-titanium oxide complex particles may be provided as a photocatalyst.

A method of preparing silver-titanium oxide complex particles according to embodiments includes: mixing an aqueous solution of titanium tetrafluoride (TiF₄) having a concentration of about 20 mM to about 100 mM and a colloidal silver solution having a concentration of about 0.1 mM to about 0.4 mM; and heat-treating the mixed solution at a temperature of about 120° C. to about 240° C.

In some embodiments, the method of preparing the silver-titanium oxide complex particles may further include adding distilled water in an amount 2 to 6 times that of the mixed solution before the heat treatment.

In some embodiments, the heat treatment may be performed for about 5 hours to about 55 hours.

In some embodiments, the colloidal silver solution may include silver nanoparticles having an average particle diameter of about 20 nm to about 100 nm.

In some embodiments, a volume ratio of the aqueous titanium tetrafluoride solution and the colloidal silver solution may be 1:0.6 to 1:1.4.

In some embodiments, the method of manufacturing the silver-titanium oxide complex particles may further include naturally cooling the heat-treated solution and separating the silver-titanium oxide complex particles through a membrane filter.

### BRIEF DESCRIPTION OF THE DRAWINGS

The above and other aspects, features, and advantages of certain embodiments of the disclosure will be more apparent from the following description taken in conjunction with the accompanying drawings.

FIG. 1 shows a scanning electron microscope (SEM) image of the silver-titanium oxide complex particles of Examples 1 to 4 and Comparative Example 5.

FIG. 2 shows a transmission electron microscope (TEM)-energy dispersive X-ray spectroscopy (EDS) element mapping image of the silver-titanium oxide complex particles of Example 1.

FIG. 3 shows an X-ray diffraction (XRD) spectrum of TiO₂ and the silver-titanium oxide particles of Examples 1 to 4.

FIG. 4 shows an absorption spectrum of the silver-titanium oxide complex particles of Examples 1 to 4 and Comparative Example 5.

FIG. 5 shows an optical band gap energy plot of the silver-titanium oxide complex particles of Examples 1 to 4 and Comparative Example 5.

FIG. 6 shows a SEM image of the silver-titanium oxide complex particles of Examples 1 and 5, and Comparative Examples 2 and 3.

FIG. 7 shows an absorption spectrum of the silver-titanium oxide complex particles of Examples 1 and 5, and Comparative Examples 2 and 3.

FIG. 8 shows an optical band gap energy plot of the silver-titanium oxide complex particles of Examples 1 and 5, and Comparative Examples 2 and 3.

### DETAILED DESCRIPTION

Nanoparticles can be made by slicing bulky materials into small pieces or by forming nano-sized particles from precursors. In the former case, it is easy to control the particle size, but it is difficult to make nanoparticles of 50 nm or less. Therefore, research and development on the latter method, that is, a method of manufacturing nanoparticles from an atomic or molecular level by using mainly a precursor material and a colloidal solution, is being actively conducted.

Reference will now be made in detail to embodiments, examples of which are illustrated in the accompanying drawings, wherein like reference numerals refer to like components throughout. In this regard, the present embodiments may have different forms and should not be construed as being limited to the descriptions set forth herein. The embodiments are merely described below, by referring to the figures, to explain aspects. As used herein, the term “and/or” includes any and all combinations of one or more of the associated listed items. Expressions such as “at least one of,” when preceding a list of components, modify the entire list of components and do not modify the individual components of the list.

Embodiments of the present disclosure provide a silver-titanium oxide complex particle which includes a plurality of titanium oxide nanoparticles aggregated with each other and a silver component bonded on the surface of the titanium oxide nanoparticles, and has an energy band gap of 3.1 eV or less. The silver-titanium oxide complex particle has increased maximum absorption wavelength and increased photo-activation efficiency.

Some embodiments provide a method of effectively preparing silver-titanium oxide complex particles.

Hereinafter, embodiments will be described with reference to the drawings. Each description and embodiments disclosed herein is also applicable to other descriptions and embodiments. That is, all combinations of the various components disclosed herein fall within the scope of the present disclosure. In addition, it cannot be seen that the technical concept of the present disclosure is limited by the detailed description provided below.

Silver-titanium oxide complex particles according to embodiments may include a plurality of titanium oxide nanoparticles aggregated with each other, and a silver component bonded on the surface of the titanium oxide nanoparticles, and may have an energy band gap of 3.1 eV or less.

The silver-titanium oxide complex particles have a band gap smaller than an energy band gap of pure titanium oxide (TiO₂) being from about 3.25 eV or about 3.2 eV. Accordingly, the silver-titanium oxide complex particles may have excellent light absorption efficiency and activity. In addition, since the maximum absorption wavelength thereof is red-shifted compared to the maximum absorption wavelength of pure titanium oxide, being about 256 nm, the activity in the visible region is high and thus, improved photoactivation efficiency may be obtained.

In some embodiments, the band gap of the silver-titanium oxide complex particle may be 3.1 eV or less, 3.0 eV or less, 2.7 eV or less, 2.4 eV or less, 2.3 eV or less, 2.0 eV or less, or 1.8 eV or less, for example, 1.0 eV or more, 1.2 eV or more, or 1.5 eV or more.

In some embodiments, the titanium oxide nanoparticles may be aggregated with each other to form a titanium oxide aggregate. In addition, at least a portion of the silver component may be supported inside the titanium oxide aggregate.

For example, a silver component may be bonded on the surface of the titanium oxide particle, and the titanium oxide particle to which the silver component is bonded may be aggregated with each other to form the silver-titanium oxide complex particle. In this case, the silver component may be substantially uniformly dispersed and distributed on the surface and inner regions of the silver-titanium complex particle, and a contact area between the silver component and the titanium oxide particle may be increased. Accordingly, a band gap of the silver-titanium oxide complex particle may be reduced, and optical properties may be improved.

The titanium oxide nanoparticle may have various shapes, such as a spherical shape, a granular shape, an angular shape, and an amorphous shape.

In some embodiments, the average particle diameter (D50) of the titanium oxide nanoparticles may be from about 5 nm to about 40 nm. In this case, the bonding property and contact area with the silver component may be improved, and due to bonding with the silver component, optical properties of the silver-titanium oxide particles may be effectively controlled. In an embodiment, the average particle diameter of the titanium oxide nanoparticles may be from about 10 nm to about 40 nm, from about 15 nm to about 40 nm, from about 5 nm to about 30 nm, from about 10 nm to about 30 nm, from about 15 nm to about 30 nm, from about 5 nm to about 25 nm, from about 10 nm to about 25 nm, or from about or 15 nm to about 25 nm.

In some embodiments, the average particle diameter of the silver-titanium oxide complex particles may be from about 100 nm to about 500 nm. In this case, the band gap may be easily adjusted to be 3.1 eV or less, and the maximum absorption wavelength may be effectively adjusted to be in the near-ultraviolet and visible light bands. In an embodiment, the silver-titanium oxide complex particles have an average particle diameter of about 120 nm to about 500 nm, from about 150 nm to about 500 nm, from about 200 nm to about 500 nm, from about 100 nm to about 400 nm, from about 120 nm to about 400 nm, from about 150 nm to about 400 nm, from about 200 nm to about 400 nm, from about 100 nm to about 250 nm, from about 120 nm to about 250 nm, from about 150 nm to about 250 nm, or from about 200 nm to about 250 nm.

In some embodiments, the silver component may include silver nanoparticles. For example, the average particle diameter of the silver nanoparticles may be from about 20 nm to about 100 nm. In this case, the bondability and contact area thereof with respect to the titanium oxide particles may be improved, and accordingly, the optical properties of the silver-titanium complex particles may be effectively improved. In an embodiment, the average particle diameter of the silver nanoparticles may be from 20 nm to about 80 nm, from about 20 nm to about 70 nm, from about 20 nm to about 60 nm, from about 30 nm to about 100 nm, from about 30 nm to about 80 nm, from about 30 nm to about 70 nm, from about 30 nm to about 60 nm, from about 40 nm to about 100 nm, from about 40 nm to about 80 nm, from about 40 nm to about 70 nm, or from 40 nm to about 60 nm.

In some embodiments, the silver-titanium oxide complex particle may have a maximum absorption wavelength greater than 320 nm. In this case, the activity of the silver-titanium oxide complex particle with respect to electromagnetic waves in the near-ultraviolet band and visible ray band, which has less energy than about 256 nm, which is the maximum absorption wavelength of pure titanium oxide, is improved and thus, photo-activation efficiency may be improved. In an embodiment, the maximum absorption wavelength of the silver-titanium oxide complex particle may be 324 nm or more, 330 nm or more, 340 nm or more, 350 nm or more, 360 nm or more, 370 nm or more, or 390 nm or more.

In some embodiments, the silver-titanium oxide complex particle may have a silver component having an average particle diameter of about 30 nm to about 80 nm distributed on the surface and inside of the titanium oxide aggregate having an average particle diameter of about 200 nm to about 400 nm.

According to embodiments, a titanium tetrafluoride (TiF₄) solution having a concentration of about 20 mM to about 100 mM and a colloidal silver solution having a concentration of about 0.1 mM to about 0.4 mM are mixed, and the mixed solution is heat treated at a temperature of about 120° C. to about 240° C. to obtain silver-titanium oxide complex particles. Accordingly, the silver component is uniformly distributed inside and on the surface of the silver-titanium oxide complex particle, and thus, the contact area between the silver component and the titanium oxide particle is increased, resulting in higher photo characteristics.

In some embodiments, the concentration of the aqueous titanium tetrafluoride solution may be from 20 mM to about 100 mM, from about 25 mM to about 30 mM, from about 30 mM to about 100 mM, from about 20 mM to about 80 mM, from about 25 mM to about 80 mM, from about 30 mM to about 80 mM, from about 20 mM to about 60 mM, from about 25 mM to about 60 mM, from about 30 mM to about 60 mM, from about 20 mM to about 50 mM, from about 25 mM to about 50 mM, or from 30 mM to about 50 mM.

In some embodiments, the concentration of the colloidal silver solution may be from 0.1 mM to about 0.3 mM, from about 0.15 mM to about 0.4 mM, or from about 0.15 to about 0.3 mM.

In some embodiments, the colloidal silver solution may include silver nanoparticles having an average particle diameter of about 20 nm to about 100 nm. In this case, the bondability and contact area thereof with respect to the titanium oxide particles may be improved, and accordingly, the optical properties of the silver-titanium complex particles may be effectively improved. In an embodiment, the average particle diameter of the silver nanoparticles may be from 20 nm to about 80 nm, from about 20 nm to about 70 nm, from about 20 nm to about 60 nm, from about 30 nm to about 100 nm, from about 30 nm to about 80 nm, from about 30 nm to about 70 nm, from about 30 nm to about 60 nm, from about 40 nm to about 100 nm, from about 40 nm to about 80 nm, from about 40 nm to about 70 nm, or from 40 nm to about 60 nm.

The aqueous titanium tetrafluoride solution and the colloidal silver solution may be mixed by a mixing method of the related art. In an embodiment, the colloidal silver solution may be added to the aqueous titanium tetrafluoride solution. In an embodiment, the aqueous titanium tetrafluoride solution may be added to the colloidal silver solution. The mixing may be performed by stirring under normal conditions.

In some embodiments, distilled water may be added to the mixed solution in an amount 2 to 6 times that of the mixed solution before the heat treatment. In this case, the silver component may be uniformly dispersed in the mixed solution, and when the titanium oxide particles are formed and aggregates are formed by their aggregation, the silver component may be uniformly dispersed and combined on the surface of the titanium oxide particles and inside and on the surface of the aggregates. In an embodiment, the distilled water may be added in an amount 2 to 5 times, 3 to 6 times, or 3 to 5 times with respect to the mixed solution.

In some embodiments, the heat treatment temperature may be from 120° C. to about 240° C., from about 120° C. to about 220° C., from about 120° C. to about 200° C., from about 140° C. to about 240° C., from about 140° C. to about 220° C., from about 140° C. to about 200° C., from about 160° C. to about 240° C., from about 160° C. to about 220° C., or from about 160° C. to about 200° C.

In some embodiments, the heat treatment may be performed for about 5 hours to about 55 hours. In this case, the silver component may be combined in a uniformly dispersed state inside and on the surface of the titanium agglomerate to form silver-titanium oxide complex particles having an increased contact area between the silver component and the titanium agglomerate, and also, the formed silver-titanium oxide complex particles may have the band gap of 3.2 eV or less. In an embodiment, the heat treatment may be performed for 5 hours to about 55 hours, about 5 hours to about 50 hours, about 5 hours to about 48 hours, about 6 hours to about 55 hours, about 6 hours to about 50 hours, about 6 hours to about 48 hours, about 10 hours to about 55 hours, about 10 hours to about 50 hours, about 10 hours to about 48 hours, about 12 hours to about 55 hours, about 12 hours to about 50 hours, about 12 hours to about 48 hours, about 20 hours to about 55 hours, about 20 hours to about 50 hours, about 20 hours to about 48 hours, about 24 hours to about 55 hours, about 24 hours to about 50 hours, or about 24 hours to about 48 hours.

In some embodiments, a volume ratio of the aqueous titanium tetrafluoride solution and the colloidal silver solution may be 1:0.6 to 1:1.4. In this case, the silver component may be combined in a uniformly dispersed state inside and on the surface of the titanium agglomerate to form silver-titanium oxide complex particles having an increased contact area between the silver component and the titanium agglomerate, and also, the formed silver-titanium oxide complex particles may have the band gap of 3.1 eV or less. In an embodiment, the volume ratio of the aqueous titanium tetrafluoride solution to the colloidal silver solution may be 1:0.6 to 1:1.3, 1:0.6 to 1:1.2, 1:0.7 to 1:1.4, 1:0.7 to 1:1.3, 1:0.7 to 1:1.2, 1:0.8 to 1:1.4, 1:0.8 to 1:1.3, or 1:0.8 to 1:1.2.

In some embodiments, the heat-treated solution may be cooled naturally and silver-titanium oxide complex particles may be separated through a membrane filter. For example, the membrane filter may have a mesh diameter of about 0.01 μm to about 0.05 μm, about 0.01 μm to about 0.04 μm, or about 0.01 μm to about 0.03 μm.

The separated particles may be washed with an organic/inorganic solvent such as water or ethanol, and then dried again. After the washing, the particles may be filtered again through a membrane filter or the like, and the drying may be performed at about 40° C. to about 80° C.

The silver-titanium oxide complex particles may be provided as a photocatalyst. The photocatalyst may act as a catalyst for accelerating the photocatalyst reaction by absorbing electromagnetic waves (light) of 3.1 eV band, for example. The photocatalytic reaction may be applied to a decomposition reaction of pollutants, odor generating substances or harmful substances, a decomposition reaction of volatile organic compounds, a reaction of obtaining oxygen and hydrogen from water, and the like. For example, the silver-titanium oxide complex particles may be applied to purifying electronic products such as air purifiers and water purifiers.

Hereinafter, it will be described in more detail through examples. However, these examples are for illustrative purposes of one or more embodiments, and the scope of the present disclosure is not limited to these examples.

### Example 1: Preparation of Silver-Titanium Oxide Complex Particles

An aqueous solution of TiF₄ was prepared by mixing 49.5 mg of titanium tetrafluoride (TiF₄) and 10 ml of distilled water.

In a 150 ml beaker, 2 ml of the TiF₄ aqueous solution, 4 ml of a colloidal silver solution (TED PELLA, PELCO NanoXact 50 nm, the silver particle size of about 50 nm, the silver mass concentration of 0.02 mg/ml, the silver component concentration of 0.185 mM), and the remaining amount of distilled water (24 ml) were added thereto and mixed to prepare a mixed solution having a total volume of 30 ml.

The mixed solution was put into an autoclave, and then, heat-treated at 180° C. for 48 hours, and subjected to a vacuum filter and a 0.02 μm mesh membrane filter (Anodisc™ 47, Whatman™), thereby obtaining synthesized powder.

The synthesized powder was washed with distilled water and ethanol, filtered again through a membrane filter, and dried at 60° C. for 2 hours to prepare silver-titanium oxide complex particles.

### Examples 2 to 4 and Comparative Example 1

Silver-titanium oxide complex particles were prepared in the same manner as in Example 1, except that the heat treatment time for the mixed solution was changed as shown in Table 1.

TABLE 1

| | | | | | Comparative |
|---|---|---|---|---|---|
| | Example 1 | Example 2 | Example 4 | Example 5 | Example 1 |
| Heat treatment | 48 | 6 | 12 | 24 | 60 |
| time (h) | | | | | |

### Example 5, and Comparative Examples 2 and 3

Silver-titanium oxide complex particles were prepared in the same manner as in Example 1, except that the amount of the colloidal silver solution used for the mixed solution was changed as shown in Table 2.

TABLE 2

| | Example | Example | Comparative | Comparative |
|---|---|---|---|---|
| | 1 | 5 | Example 2 | Example 3 |
| Silver colloidal solution (ml) | 4 | 2 | 1 | 6 |
| TiF₄ solution: colloidal silver | 1:2 | 1:1 | 0.5 | 1.5 |
| solution (volume ratio) | | | | |

### Experimental Example 1: Scanning Electron Microscope (SEM) Analysis

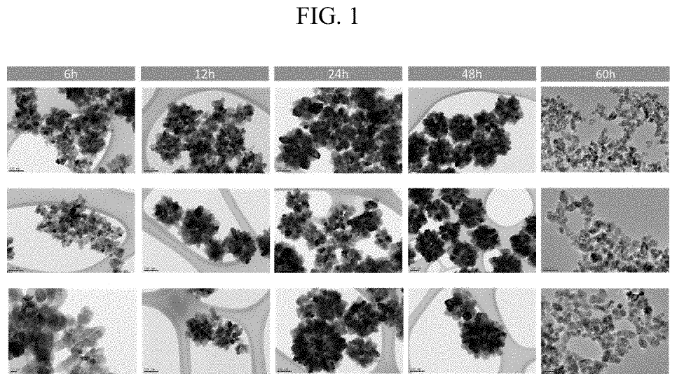

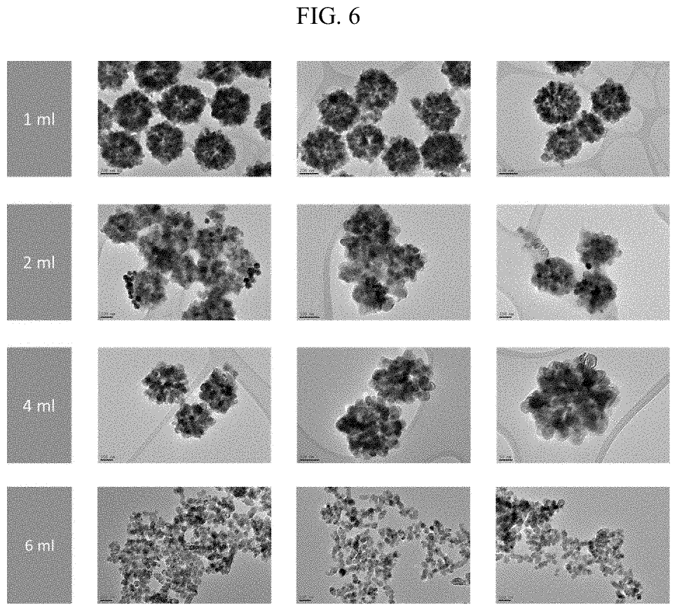

The images of FIGS. 1 and 6 were obtained by scanning electron microscopy (SEM) of the silver-titanium oxide complex particles of Examples and Comparative Examples.

FIG. 1 shows a SEM image of the silver-titanium oxide complex particles of Examples 1 to 4 and Comparative Example 5, and FIG. 6 shows a SEM image of the silver-titanium oxide complex particles of Examples 1 and 5, and Comparative Examples 2 and 3.

Referring to FIG. 1, in the case of the silver-titanium oxide complex particles of Examples 1 to 4, it can be seen that a silver component (dark part) was bonded on the surface of the titanium oxide (bright part) particle, and in the case of the silver-titanium oxide complex particles of Comparative Example 5, it can be seen that the titanium oxide and the silver component were substantially separated.

Specifically, it was confirmed that the silver component was evenly distributed on the titanium oxide particles when the heat treatment time was about 12 hours or more, and the uniformity of distribution of the silver component and the uniformity of the size of silver-titanium oxide complex particle were gradually increased until the heat treatment time was about 48 hours. When the heat treatment time was 60 hours or more, it can be seen that the silver component was not substantially bonded on the surface of the titanium oxide particles.

Referring to FIG. 6, in the case of the silver-titanium oxide complex particles of Examples 1 and 5, it can be seen that a silver component was bonded on the surface of the titanium oxide particles, and in the case of the silver-titanium oxide complex particles of Comparative Example 5, it can be seen that titanium oxide and the silver component were substantially separated.

Specifically, when the amount of the colloidal silver solution used was 4 ml, it was confirmed that the uniformity of distribution of the silver component and the uniformity of the silver-titanium oxide complex particle size were excellent. However, when the amount of the colloidal silver solution used was 1 ml, only titanium oxide aggregates were formed in which the silver component was not adsorbed or supported. In addition, when the amount of the colloidal silver solution used was 6 ml, the titanium oxide particles did not aggregate with each other, and the silver component was not substantially bonded on the surface of the titanium oxide particles, that is, the silver component was present as being separated therefrom.

### Experimental Example 2: Transmission Electron Microscope (TEM)-Energy Dispersive X-Ray Spectroscopy (EDS) Analysis

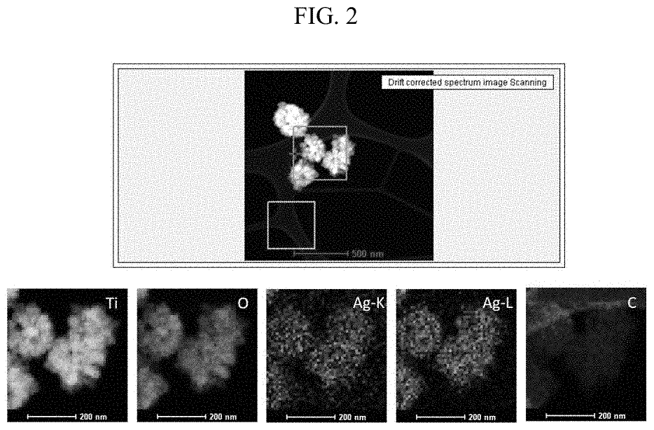

TEM-EDS analysis was performed on the silver-titanium oxide complex particles of Example 1 through FE-TEM (EM912, Carl Zeiss, 120 kV) to obtain the element mapping image of FIG. 2. FIG. 2 shows a TEM-EDS element mapping image of the silver-titanium oxide complex particles of Example 1.

Referring to FIG. 2, it was confirmed that the silver (Ag) element was distributed in a distribution shape substantially the same as the distribution of titanium (Ti) and oxygen (O) elements and the contour formed therefrom. The results show that the silver component was substantially uniformly dispersed inside and outside the titanium complex particles.

### Experimental Example 3: X-Ray Diffraction (XRD) Analysis

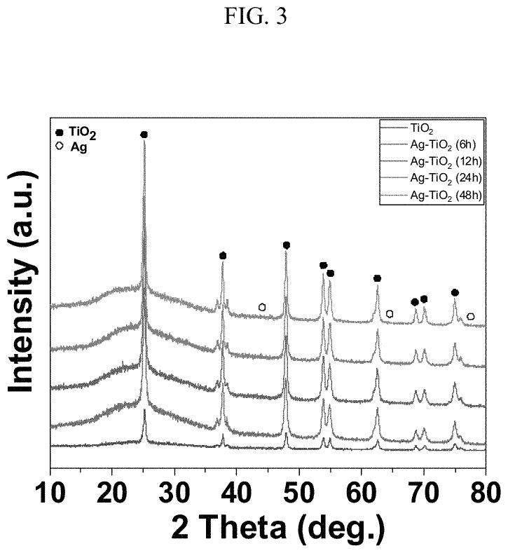

Pure TiO₂ and the silver-titanium oxide complex particles of Examples 1 to 4 were subjected to XRD analysis to obtain the spectrum of FIG. 3. FIG. 3 shows an XRD spectrum of TiO₂ and the silver-titanium oxide particles of Examples 1 to 4.

Referring to FIG. 3, the XRD peak corresponding to the silver (Ag) crystal was not present in the silver-titanium oxide complex particles of Examples 1 to 4. This indicates that the silver component of the nanometer scale size was uniformly distributed in the titanium complex oxide particles.

### Experimental Example 4: Analysis of Maximum Absorption Wavelength

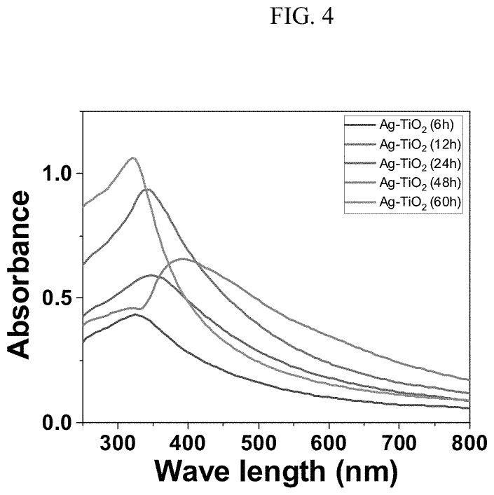

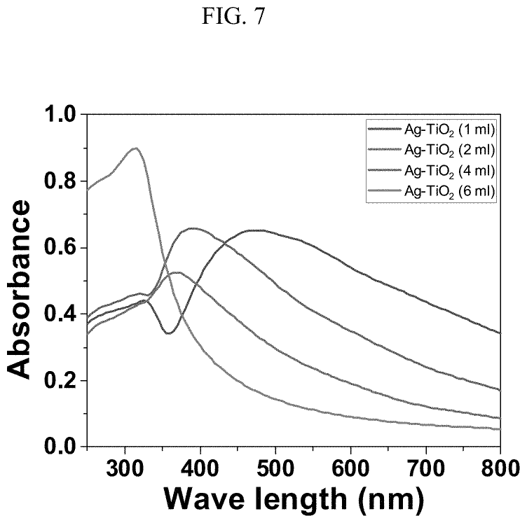

Pure TiO₂, and 10 mg of silver-titanium oxide complex particles of Examples and Comparative Examples were each dispersed in 10 ml of distilled water, and the absorption spectra thereof were measured using an ultraviolet-visible-near-infrared spectrophotometer (LAMBDA 950, Perkin Elmer) to obtain the wavelength-absorbance graph of FIGS. 4 and 7. The maximum absorption wavelengths are shown in Tables 3 and 4.

TABLE 3

| | | Example | Example | Example | Example | Comparative |
|---|---|---|---|---|---|---|
| | TiO₂ | 1 | 2 | 4 | 5 | Example 1 |
| Maximum | 256 | 391 | 324 | 341 | 348 | 320 |
| absorption | | | | | | |
| wavelength | | | | | | |
| (nm) | | | | | | |

TABLE 4

| | | | | Comparative | Comparative |
|---|---|---|---|---|---|
| | TiO₂ | Example 1 | Example 5 | Example 2 | Example 3 |
| Maximum absorption | 256 | 391 | 366 | 325 | 314 |
| wavelength (nm) | | | | | |

FIG. 4 shows an absorption spectrum of the silver-titanium oxide complex particles of Examples 1 to 4 and Comparative Example 5, and FIG. 7 shows an absorption spectrum of the silver-titanium oxide complex particles of Examples 1 and 5, and Comparative Examples 2 and 3.

Referring to FIG. 4 and Table 3, the silver-titanium oxide complex particles of Examples 1 to 4 had a maximum absorption wavelength greater than 320 nm, which is higher than pure TiO₂ and the silver-titanium oxide complex of Comparative Example 1.

Referring to FIG. 7 and Table 4, the silver-titanium oxide complex particles of Examples 1 and 5 had a maximum absorption wavelength greater than 330 nm, which is higher than pure TiO₂ and the silver-titanium oxide complex of Comparative Examples 2 and 3.

### Experimental Example 5: Band Gap Analysis

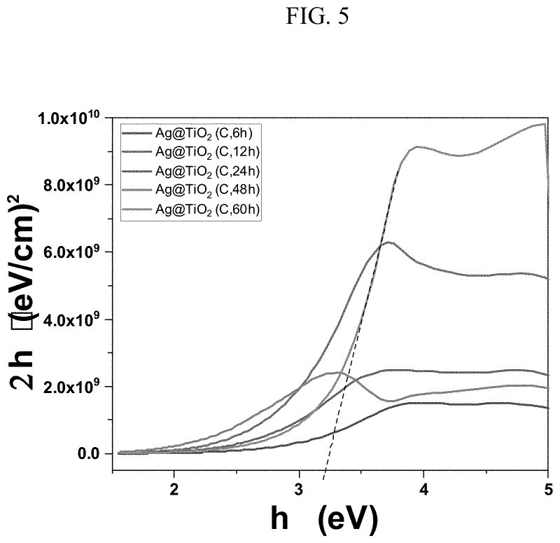

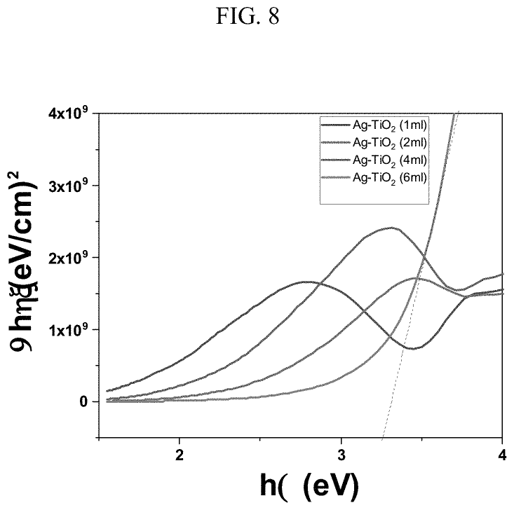

10 mg of each of the silver-titanium oxide complex particles of Examples and Comparative Examples was dispersed in 10 ml of distilled water, and the UV-Vis absorption spectra thereof were measured through an ultraviolet-visible-near-infrared spectrophotometer (LAMBDA 950, Perkin Elmer), which were then directly transferred to a transition Tauc plot ((αhv)² vs. hv; α is the extinction coefficient) to obtain the optical bandgap energy plots of FIGS. 5 and 8, and, in each graph, the extrapolation values, obtained by extending the maximum slope, with respect to the X axis, were defined as energy band gaps, which are shown in Tables 5 and 6.

TABLE 5

| | Example | Example | Example | Example | Comparative |
|---|---|---|---|---|---|
| | 1 | 2 | 4 | 5 | Example 1 |
| Band Gap (eV) | 1.78 | 2.58 | 2.62 | 2.27 | 3.2 |

TABLE 6

| | Example | Example | Comparative | Comparative |
|---|---|---|---|---|
| | 1 | 5 | Example 2 | Example 3 |
| Band Gap (eV) | 1.78 | 2.39 | 3.14 | 3.25 |

FIG. 5 shows an optical band gap energy plot of the silver-titanium oxide complex particles of Examples 1 to 4 and Comparative Example 5. FIG. 8 shows an optical band gap energy plot of the silver-titanium oxide complex particles of Examples 1 and 5, and Comparative Examples 2 and 3.

Referring to FIG. 5 and Table 5, the silver-titanium oxide complex particles of Examples 1 to 4 had a band gap of less than 3.1 eV, which is smaller than those of the silver-titanium oxide complex of pure TiO₂ and Comparative Example 1.

Referring to FIG. 7 and Table 4, the silver-titanium oxide complex particles of Examples 1 and 5 had a band gap of 3.1 eV or less, which is smaller than those of the silver-titanium oxide complex of Comparative Example 1.

In the silver-titanium oxide complex particles according to an embodiment, the silver component is evenly distributed inside and on the surface of the aggregate in which the titanium oxide nanoparticles are aggregated, so that the contact area between the titanium oxide and the silver component may be increased. Accordingly, the band gap of the titanium oxide is reduced and the maximum light absorption wavelength is increased, so that the photoactivation efficiency for the surface plasmon resonance phenomenon may be improved.

According to an embodiment, by mixing a predetermined concentration of an aqueous solution of titanium tetrafluoride and a colloidal silver solution and heat-treating the mixture, the silver-titanium oxide complex particles in which the silver component is evenly distributed inside and on the surface of the aggregate may be prepared.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

What is claimed is:

1. Silver-titanium oxide complex particles comprising:
a plurality of titanium oxide nanoparticles aggregated with each other; and
a silver component bonded on a surface of the titanium oxide nanoparticles, wherein an energy band gap of the silver-titanium oxide complex particles is 3.1 eV or less.

2. The silver-titanium oxide complex particles of claim 1, wherein an average particle diameter of the titanium oxide nanoparticles is from about 5 nm to about 40 nm.

3. The silver-titanium oxide complex particles of claim 1, wherein an average particle diameter of the silver-titanium oxide complex particles is from about 100 nm to about 500 nm.

4. The silver-titanium oxide complex particles of claim 1, wherein the silver component comprises silver nanoparticles having an average particle diameter of about 20 nm to about 100 nm.

5. The silver-titanium oxide complex particles of claim 1, wherein the titanium oxide nanoparticles are aggregated with each other to form a titanium oxide aggregate, and
wherein at least a portion of the silver component is supported inside the titanium oxide aggregate.

6. The silver-titanium oxide complex particles of claim 1, wherein a maximum absorption wavelength of the silver-titanium oxide complex particles is greater than 320 nm.

7. The silver-titanium oxide complex particles of claim 1, wherein the silver component having an average particle diameter of about 30 nm to about 80 nm is distributed on the surface and inside of a titanium oxide aggregate having an average particle diameter of about 200 nm to about 400 nm.

8. The silver-titanium oxide complex particles of claim 1, wherein the silver-titanium oxide complex particles are provided as a photocatalyst.

9. A method of producing silver-titanium oxide complex particles, the method comprising:
mixing an aqueous solution of titanium tetrafluoride (TiF₄) having a concentration of about 20 nm to about 100 nm and a colloidal silver solution having a concentration of about 0.1 mM to about 0.4 mM; and
heat-treating the mixed solution at a temperature of about 120° C. to about 240° C.

10. The method of claim 9, further comprising adding distilled water in an amount 2 times to 6 times that of the mixed solution before the heat treatment.

11. The method of claim 9, wherein the heat treatment is performed for about 5 hours to about 55 hours.

12. The method of claim 9, wherein the colloidal silver solution comprises silver nanoparticles having an average particle diameter of about 20 nm to about 100 nm.

13. The method of claim 9, wherein a volume ratio of the aqueous titanium tetrafluoride solution to the colloidal silver solution is 1:0.6 to 1:1.4.

14. The method of claim 9, further comprising: naturally cooling the heat-treated solution and separating the silver-titanium oxide complex particles through a membrane filter.
